(19) United States
(12) Patent Application Publication
(10) Pub. No.: US 2012/0055508 A1
(43) Pub. Date: Mar. 8, 2012

(54) DEVICE FOR DISPLACING MATERIAL LYING ON A FLOOR

(75) Inventor: Karel Van Den Berg, Bleskensgraaf (NL)

(73) Assignee: LELY PATENT N.V., Maassluis (NL)

(21) Appl. No.: 13/210,399

(22) Filed: Aug. 16, 2011

Related U.S. Application Data
(63) Continuation of application No. PCT/NL2010/000023, filed on Feb. 12, 2010.

(30) Foreign Application Priority Data
Feb. 17, 2009 (NL) 1036587

(51) Int. Cl. A47L 11/00; B08B 1/00

(52) U.S. Cl. 134/6; 15/50.1

(57) ABSTRACT

The present invention relates to an assembly for displacing material present on a stable floor, including an unmanned self-propelled device having a frame, wherein the frame is provided with a slide for displacing the material and with at least one brush, wherein the assembly further includes setting means for automatically and selectively setting the intensity of the contact of the brush with the floor.

### CROSS REFERENCE TO RELATED APPLICATIONS

This is a continuation of PCT/NL2010/000023 filed on 12 Feb. 2010, which claims priority from Netherlands patent application no. 1036587 filed 17 Feb. 2009, the contents of both applications are hereby incorporated by reference in their entireties.

### BACKGROUND OF THE INVENTION

1. Field of the Invention

The invention relates to an unmanned self-propelled device, provided with a brush, for displacing material present on a stable floor, such as manure or feed. The invention also relates to a method of displacing material present on a stable floor.

2. Brief Description of Related Art

DE 20 2006 007378, which is hereby incorporated by reference in its entirety, discloses an unmanned self-propelled device, comprising a pair of wheels and a manure slide (also called scraper), which also forms a front wall for a chamber which accommodates a brush arrangement. The brush arrangement comprises a series of cleaning fingers which are freely rotatable about a horizontal axis which is transverse to the direction of travel. The fingers are intended to extend into transverse slots of the floor in order to clean these slots.

DE 20 2006 001258, which is hereby incorporated by reference in its entirety, shows a device, provided with a drive and a control, for displacing manure, wherein a number of rotatingly driven brushes are arranged behind a manure slide (scraper), wherein the axes of rotation are parallel to the direction of travel, in order to be able to extend into transverse slots of the floor by means of the brush bristles.

The known devices are less applicable for combatting film formation on a stable floor or removing a film which has been formed on a stable floor.

### SUMMARY OF THE INVENTION

One or more of the aforementioned disadvantages is addressed by the present invention, namely, a self-propelled device, method therefor and assembly thereof, for displacing material present on a stable floor, by means of which film formation on a stable floor can be combated effectively.

In one embodiment, the present invention provides a self-propelled device, method therefore and assembly thereof, for displacing material present on a stable floor, by means of which the removal of film formed on a stable floor is facilitated.

In another embodiment, the present invention provides a self-propelled device, method therefore and assembly thereof, for displacing material present on a stable floor, by means of which multifunctional adaptation to conditions on the floor is possible.

In accordance with various aspects of the present invention, an assembly for displacing material present on a stable floor is provided, the assembly comprising an unmanned self-propelled device having a frame, wherein the frame is provided with a slide for displacing the material and with at least one brush, wherein the assembly further comprises setting means (e.g., setting mechanism) for automatically and selectively setting the intensity of the contact of the brush with the floor. This makes it possible to influence the functionality of the brush automatically and thus efficiently.

In one embodiment, the setting means are configured to set the intensity of the contact of the brush with the floor in dependence on the condition of the floor and/or of the surroundings (in particular climate parameters, such as temperature, moisture and air pressure) and/or of the travelling (speed and/or direction) of the device, so that the brush can be active in an optimum manner in adaptation thereto. For detecting one or more of said conditions, the assembly can be provided with detectors which can be mounted on the device or be mounted in or near the stable floor and then communicate in a wireless manner with a control unit on the device.

The assembly can be provided with a control unit which controls the setting means and which is provided with means for pre-programming the operation of the setting means in relation to the condition detected by the detectors. This makes it possible for the farmer to pre-control the operation of the setting means according to his experience. When detecting the conditions on the floor and/or surroundings, it is possible for the setting means, for example when the operation is started, to make a setting which can then be maintained during a period of time, for example a part of a day, or, if desired, can be changed automatically if the measured condition changes to a certain extent. In the case of adaptation to the travelling, the change will take place during operation.

For detecting manure and the like on the floor, use can be made of a detector which is configured to detect material present on the floor, preferably in 2D or 3D form and/or dimensions.

Use can be made of a detector which is configured to detect the temperature of the surface of the floor and/or of the space immediately above the floor. By means thereof it is, for example, possible to detect a hot floor, and to adapt the intensity of the contact of the brush with the floor thereto. If the detector is disposed on the device, it is also possible to detect, by means of an IR sensor, a local temperature change, for example a temperature rise as a result of a recently produced amount of urine or thin manure. The operation of the brush can then locally be adapted thereto.

Use can also be made of a detector which is configured to measure the moisture content on and/or above the floor.

In another embodiment, the brush is designed as a rotatable brush, wherein the device is provided with drive means for driving the rotatable brush (e.g., drive mechanism), wherein the setting means comprise control means for the drive means for automatically and selectively controlling the number of revolutions and/or the direction of rotation of the brush. By thus automatically controlling the driven number of revolutions, for example from zero revolutions, in which case the brush can be in detained position or in clearance position, to a first specific number of revolutions, or from a first specific number of revolutions to a second specific number of revolutions, or from a number of revolutions in one direction to a number of revolutions in opposite direction of the rotating brush, adaptation to the actual condition on the floor can take place. In one embodiment, it is for example possible to decide to have the brushes operate in dry conditions (detected for example by the aforementioned moisture detector) at a higher number of revolutions than in wet conditions, in order thus to influence the intensity of the cleaning.

The brush can have a substantially horizontal rotational centre line. The rotational centre line can, for example, be parallel to the direction of travel, or be transverse thereto, as known per se.

The effectiveness of the brush can be enhanced if the control means, e.g., control mechanism, are configured to control the number of revolutions in dependence on the speed of travel of the device. For example, in one embodiment, the control means are configured to control the number of revolutions of the brush in such a manner that the circumferential speed at the lower side of the brush is equal to the speed of travel of the device but opposite in sign. The brush can then function as a bearing roller, in which case the brush will hardly be susceptible of wear. In another embodiment, the control means are configured to control the number of revolutions of the brush in such a manner that the circumferential speed at the lower side of the brush differs from the speed of travel of the device, is preferably greater, and opposite in sign. It is, for example, possible to effect more or less skid of the brush on the floor.

The control means can be configured to control the drive means for selective setting of the direction of rotation of the brush, for example selective setting of the direction of rotation of the brush in dependence on the direction of travel of the device. When the direction of travel is inversed, such as in the case of driving in reverse, the direction of rotation of the brush can be adapted thereto.

The control means can be configured to control the drive means for selective setting of the number of revolutions of the brush in dependence on the speed of travel of the device.

Adaptation to the condition of/on the floor is further enhanced if the setting means are configured to set the height of the brush with respect to the frame, so that a plurality of operative positions are possible.

Adaptation to the condition of/on the floor is also enhanced if the setting means are configured to set the pressure of the brush on the floor. This is, for example, possible in an embodiment in which the brush is fastened to a holder and is fastened therewith to the frame, wherein the holder is fastened to the frame at the location of an adjustable connection which forms part of the setting means. In particular, the adjustable connection can form a pivot point with a substantially horizontal rotational centre line and be adjustable in horizontal direction for setting the distance between the brush and the pivot point.

In one embodiment, the device can comprise a slide for displacing material present on a stable floor, wherein the brush is preferably arranged behind the slide when viewed in the direction of travel. One of ordinary skill in the art will appreciate that the slide can comprise any suitable slide for use to displace material on floors such as stable floors. The slide can be concave in top view, with the hollow side oriented forwardly.

The slide can be fastened to the holder at a location at the side of the adjustable connection which faces away from the brush. The slide and the brush can thus be interconnected by a holder, which holder is fastened to the frame at the location of a pivot point in a manner in which it is rotatable in a vertical plane, wherein the distance between the brush and the slide to the pivot point is adjustable. The pivot point can be located between the slide and the brush, so that increase of the pressure on the brush by the aforementioned setting can result in a decrease of the pressure of the slide on the floor, and vice versa.

In one embodiment, the invention provides an unmanned self-propelled device for displacing material present on a floor, comprising a frame with a slide, wherein the frame is provided with at least one rotatable brush, wherein the frame is further provided with drive means for driving the rotatable brush, wherein the brush is mounted on the frame in such a manner that the operating pressure of the brush can be set, in particular by controlling the number of revolutions thereof.

In another embodiment, the invention provides an unmanned self-propelled device for displacing material present on a floor, comprising a frame with a slide, wherein the frame is provided with at least one rotatable brush which is arranged behind the slide, wherein the frame is further provided with drive means for driving the rotatable brush, wherein the device has a longitudinal direction, to which the direction of travel of the device is parallel during operation, wherein the brush is drivable about a horizontal centre line which is transverse to the longitudinal direction.

The usability of the device according to the invention is enhanced if it is self-steering, not urged by fixed guide means.

In accordance with various aspects of the present invention, a method of removing material from a stable floor surface with the aid of a slide provided on an unmanned self-propelled device and at least one brush provided on said device is provided, wherein the intensity of the contact of the brush is controlled automatically in dependence on one or more condition parameters, such as the condition of the floor and/or of the surroundings and/or of the travelling (speed and/or direction) of the device.

In one embodiment, said intensity is controlled by setting the height of the brush with respect to the floor.

In another embodiment, said intensity is controlled by setting the part of the weight of the device which is supported on the floor via the brush.

In yet another embodiment, the brush is a rotatingly driven brush, wherein said intensity is controlled by setting the direction of rotation and/or the rotational speed of the brush.

In a further embodiment, the brush is driven in rotation at a circumferential speed which is greater than the speed of travel, wherein the direction of rotation of the brush at the location of the contact of the brush with the floor is opposite to the direction of travel.

In yet a further embodiment, the brush is driven in rotation at a circumferential speed which is equal to the speed of travel, wherein the direction of rotation of the brush at the location of the contact of the brush with the floor is opposite to the direction of travel.

In one embodiment of the method according to the invention, the device can move over the floor at a speed, in a selected one of two opposite directions of travel, and the brush can be driven in rotation in a direction in dependence on the selected direction of travel.

In accordance with various aspects of the present invention, a method of removing material from a stable floor surface with the aid of a slide is provided on a mobile device and a brush provided on said device, wherein the operating pressure of the brush on the floor is set in dependence on the condition of the floor and/or the surroundings. By setting the pressure on the bristles it is possible to adapt to the condition on or at the floor, such as the formation behind the slide of a film which is difficult to remove, the floor being hot or cold, the extent to which the material adheres to the floor, et cetera. In one embodiment, the pressure of the slide on the floor and the pressure of the brush on the floor are set in mutual dependency, preferably according to inverse proportion, by which is meant that an increase of the pressure for the one results in a decrease of the pressure for the other.

In this case, use can be made of a brush which is rotatable about a substantially horizontal rotational centre line, preferably about a rotational centre line transverse to the direction of travel, preferably of a motor-driven brush.

The mobile device used in the above described methods can be unmanned self-propelled, in particular also self-steering.

It is observed that by unmanned self-propelled and possibly self-steering devices are meant both at least substantially autonomously travelling and possibly autonomously steering devices, whether or not programmed for this purpose, such as the Discovery (registered trademark) manure slide of the registered trademark Lely, and devices in which the travelling and/or steering are/is remotely controlled. In both cases, a motor for the travelling of the device is provided in the device.

### BRIEF DESCRIPTION OF THE FIGURES

The invention will be explained with reference to a number of exemplary embodiments shown in the accompanying figures, in which:

FIGS. 1A and 1B show a schematic side view and a top view, respectively, of one embodiment of a device according to the invention, and

FIGS. 2A and 2B show a schematic side view and a top view, respectively, of a one embodiment of a device according to the invention.

### DETAILED DESCRIPTION OF THE FIGURES

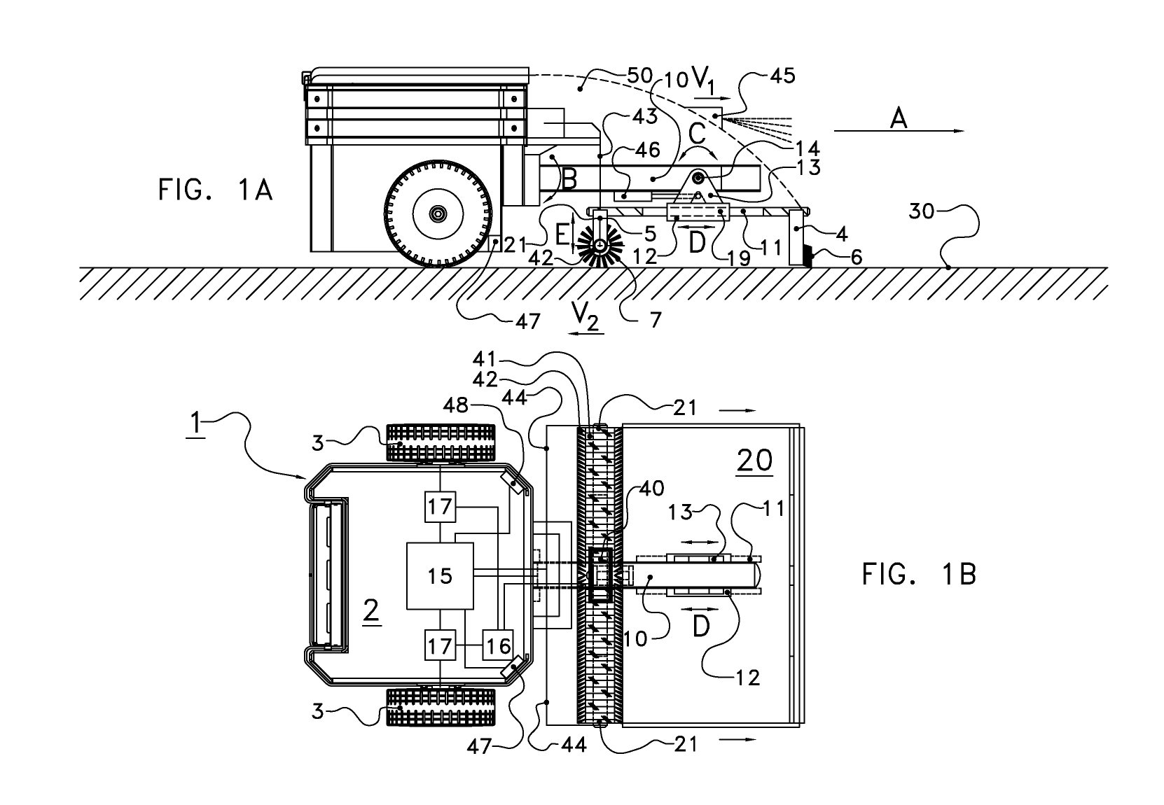

The features and advantages of the invention will be appreciated upon reference to the following drawings, in which: the device 1 shown in FIGS. 1A and 1B for removing manure from a floor 30 of a passageway of a stable comprises a relatively heavy, block-shaped concrete housing 2 with two wheels 3 and a tandem arrangement, located below a hood 50, of a manure slide or scraper 4 and a brush member 5 which are interconnected by a steel plate 20 which is rigid against bending. The manure slide 4 and the brush member 5 form with the plate 20 a movable unit which is suspended from a longitudinal bar 10 which is itself fastened to the housing 2 and extends forwardly therefrom. The device 1 is supported on the floor 30 by means of the wheels 3, the manure slide 4 and the brush member 5. The housing 2 is provided on both sides with current collectors by means of which an accumulator 16, included in the housing 2, can be charged at an external charging station, as used in the manure slide device which is offered by Lely (registered trademark) under the name Discovery (registered trademark).

The housing 2 accommodates a control unit 15 which is fed by the accumulator 16 and which controls, via the control line 18, a double electric motor 17, by means of which the wheels 3 can be driven individually. The control unit 15 is capable of being programmed remotely, so that the device 1 can follow autonomously a defined working route, in a repeating manner.

The manure slide 4, which is concave in an alternative embodiment with the hollow side oriented forwardly, is made of stainless steel with a polyurethane strip 6 at the lower edge, for sweeping contact with the floor 30. The brush member 5 is provided with a rotatingly driven brush 7 by means of which a possible film-shaped dirt layer on the floor 30 can be detached and/or swept away. The longitudinal bar 10 is bearing-supported freely rotatably about its centre line in the housing 2, direction B, so that the unit of plate 20 and members 4 and 5 can adapt to the course of the floor 30 in a direction transverse to the direction of travel A. The plate 20 is provided with a slot 11 for receiving the vertical body of an H-shaped slide 19 which is fastened to an upright fork 13. The fork 13 is pivotably attached, by means of the pivot pin 14 in direction C, to the front end of the horizontal longitudinal bar 10. As a result thereof, the plate 20 with the members 4,5 is capable of tilting as a unit in the direction C, for following the floor 30. The slot 11 is longer than required for the slide 12, in order to be able to set the position of the pivot pin 14 with respect to the members 4,5 (direction D). The end of a piston rod of a cylinder 46, which is itself fastened to the lower side of the longitudinal bar 10, is mounted on the upper plate of the slide 19, extending between the legs of the fork 13. The cylinder is connected, by means of a non-shown line, to a pressure source and, by means of a non-shown line, to the control unit 15. By operating the cylinder 46, the slide 19 can be displaced with respect to the slot 11 and be positioned. As a result thereof, the pivot pin 14 can be positioned closer to the front member 4 than to the rear member 5, for example at approximately ⅓ of the mutual distance between the members 4 and 5. This makes it possible to influence the pressure with which the members 4 and 5, and consequently the brush 7, engage the floor during operation, such as via a pressure setting mechanism.

The brush 7, which is also shown in top view with omission of the plate 20 for illustrative reasons, is designed as a so-called drum brush with a horizontal rotational centre line transverse to the longitudinal direction or direction of travel A, wherein an electric motor 40 ensures the drive of a cylinder-shaped case 41 on which the brush bristles 42 are mounted, located within the case. For the current supply, there is provided a line 43 between the accumulator 16 and the motor 40. The motor 40 is controlled by the control unit 15 which also controls the double electric motor 17.

The brush 7 has its ends fastened, for example by means of spindle motors 21, in a height-adjustable manner to the marginal areas of the plate 20. The spindle motors 21 are connected via lines 44 to the control unit 15 and the accumulator 16. By operating the spindle motors 21 it is possible to set the position of the brush 7 with respect to the plate 20 (direction E) and to influence the brush pressure on the floor 30, in particular in an alternative embodiment in which the hinge connection 14 is absent.

On top, at the front, of the hood 50 there is provided a 3D sensor for recognizing manure spots on the stable floor 30. At the bottom, at the front, of the housing 2 there are provided a temperature sensor 47 and a moisture meter 48, which are connected via lines to the control unit 15. The data of these parameters for the surroundings, the temperature of the floor or the immediate surroundings and the moisture content can form an indication of the condition of a contaminated stable floor or the expected condition thereof. These detectors can also be provided in the stable as stationary ones and then transmit data in a wireless manner to the control unit 15.

The number of revolutions and the direction of rotation of the electric motor 40 can be controlled by the control unit 15. In one mode to be selected remotely, when travelling in the direction A, the brush 7 is rotated by the motor 40 in the direction F and, when travelling in opposite direction, in direction G. The control unit 15 can control the motor 40 in accordance with to the motors 17. It can thus be ensured that the circumferential speed V2 of the brush bristles 42 at the location of the contact with the floor 30 is equal to the speed of travel V1, in which case the brush 7 runs over the floor, or has, to a greater or smaller extent, a reduced contact with the floor, in order to be able to exercise a desired influence on the floor 30.

The control unit 15 can be programmed as regards one or more relations between number of revolutions of the brush 7 and speed of travel of the device 1. The user can remotely select the desired relation. The control of the number of revolutions of the brush in the control unit 15 can also be adapted to data from the temperature meter 47 and/or the moisture meter 48. The control unit 15 can also control the cylinder 45 and/or the spindle motors 21 according to a previously inputted connection between, on the one hand, brush height and/or brush pressure and, on the other hand, temperature and/or moisture content, as well as the presence, and possibly shape and dimensions in 3D and/or 2D, of manure spots. This makes it possible to adapt the intensity of the contact of the brush 7 with the floor 30 automatically and before and also during operation, attuned to the actual conditions. Another useful environment parameter can be the air pressure, for which purpose a meter can also be connected to the control unit 15. Connection can also take place by means of an interne connection.

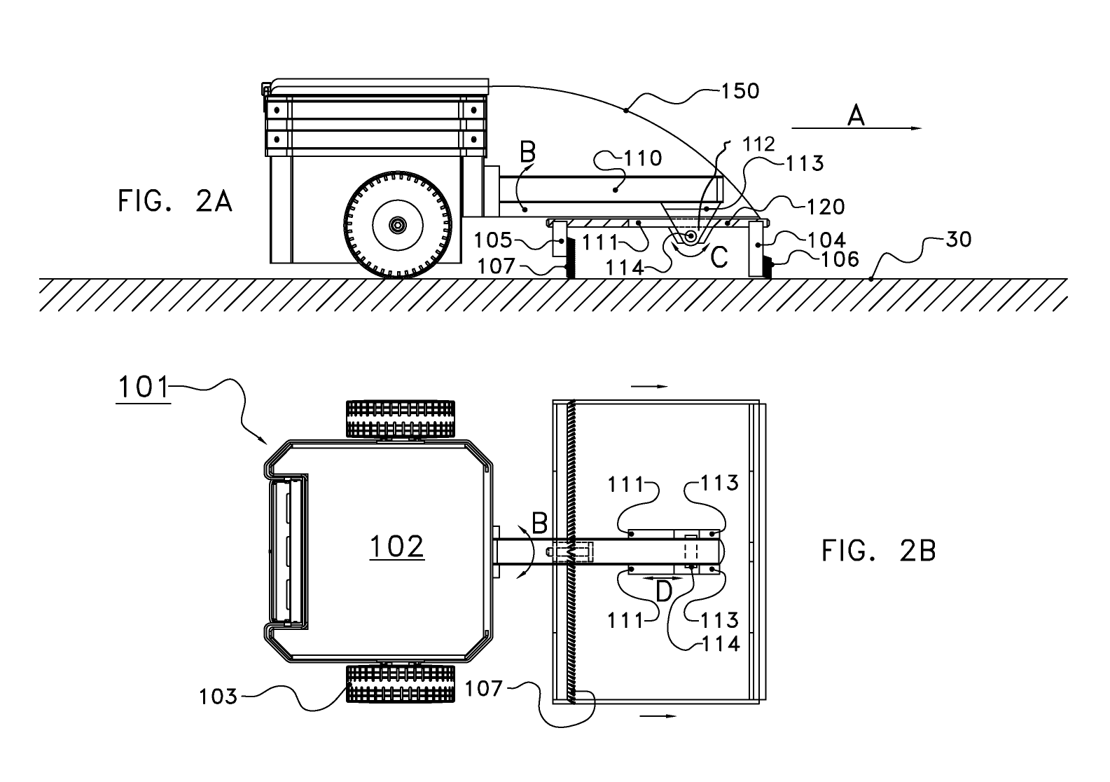

The device 101 shown in FIGS. 2A and 2B comprises a housing 102, a hood 150, a fixed brush 107 and a manure slide 104/106. The brush 107 is also shown in top view with omission of the plate 20 for illustrative reasons. The device 101 is supported on the floor 30 by means of the wheels 103, the brush 107 and the manure slide 104/106. A longitudinal bar 110, which is bearing-supported freely rotatably about its centre line, extends forwardly, direction B. The plate 120 is provided with two slots 111 for passage of the two plates of a fork 113 which is fixed to the front end of the horizontal longitudinal bar 110. By a pivot pin 114 located below the plate 120, the fork 113 is attached rotatably, in the direction C, to a downwardly extending plate 112 which is fastened to the lower side of the plate 120, so that the plate 120 with the members 104,105 can tilt in that direction as a unit in order to follow the floor 130. Owing to the low position of the rotational centre line, the arm of the moment of the force caused by manure and the floor against the slide 104 is limited. The slots 111, just like in the previous example, are longer than required for the fork 113, in order to be able to set the position of the pivot pin 114 with respect to the members 104,105 (direction D), by means of a non-shown cylinder, as is also possible in the embodiment of FIGS. 1A and 1B.

The embodiment of FIGS. 2A and 2B can be provided with sensors/detectors as can also be present in the embodiment of FIGS. 1A and 1B, in connection with the control unit 115. The brush 107 can also be set in height, for example by means of the aforementioned spindle motors, controlled by the control unit 115. The setting of the intensity of the contact of the brush 107 with the floor 30 is substantially comparable to the embodiment of FIGS. 1A and 1B, with exception of the number of revolutions of the brush.

Thus, the invention has been described by reference to certain embodiments discussed above. It will be recognized that these embodiments are susceptible to various modifications and alternative forms well known to those of skill in the art. Further modifications in addition to those described above may be made to the structures and techniques described herein without departing from the spirit and scope of the invention. Accordingly, although specific embodiments have been described, these are examples only and are not limiting upon the scope of the invention.

1. An assembly for displacing material present on a stable floor, comprising an unmanned self-propelled device having a frame, wherein the frame is provided with a slide for displacing the material and with at least one brush, wherein the assembly further comprises a setting mechanism for automatically and selectively setting the intensity of the contact of the brush with the floor.

2. The assembly according to claim 1, wherein the setting mechanism is configured to set the intensity of the contact of the brush with the floor in dependence on at least one condition of at least one of: the floor, a surrounding of the brush, and a travel condition of the device.

3. The assembly according to claim 2, where the condition of the surrounding includes at least one of: a climate parameter comprising at least one of: temperature, moisture and air pressure.

4. The assembly according to claim 2, wherein the travelling condition comprises at least one of: speed and direction of the device.

5. The assembly according to claim 2, comprising one or more detectors for detecting one or more of said conditions.

6. The assembly according to claim 3, further comprising a control unit that controls the setting mechanism and a mechanism for pre-programming the operation of the setting mechanism in relation to the condition detected by the detectors.

7. The assembly according to claim 6, wherein the detector is configured to detect material in at least one of: 2D form, 2D dimension, 3D form, and 3D dimension.

8. The assembly according to claim 5, wherein the detector is configured to detect the temperature of at least one of: the surface of the floor and of the space immediately above the floor.

9. The assembly according to claim 5, wherein the detector is configured to measure the moisture content of at least one of: on and above the floor.

10. The assembly according to claim 1, wherein the brush is designed as a rotatable brush, wherein the device is provided with a drive mechanism for driving the rotatable brush, wherein the setting mechanism comprises a control mechanism for the drive mechanism for automatically and selectively controlling at least one of: a number of revolutions and a direction of rotation of the brush.

11. The assembly according to claim 10, wherein the brush has a substantially horizontal rotational centre line oriented transversely to the direction of travel of the device.

12. The assembly according to claim 10, wherein the control mechanism is configured to control the number of revolutions of the brush in dependence on the speed of travel of the device.

13. The assembly according to claim 12, wherein the control mechanism is configured to control the number of revolutions of the brush such that the circumferential speed at the lower side of the brush is equal to the speed of travel of the device but opposite in sign.

14. The assembly according to claim 13, wherein the control mechanism is configured to control the number of revolutions of the brush such that the circumferential speed at the lower side of the brush differs from the speed of travel of the device opposite in sign.

15. The assembly according to claim 14, wherein the circumferential speed is greater than the speed of travel of the device.

16. The assembly according to claim 10, wherein the control mechanism is configured to control the direction of rotation of the brush in dependence on the direction of travel of the device.

17. The assembly according to claim 1, wherein the setting mechanism is configured to set the height of the brush with respect to the frame.

18. The assembly according to claim 1, wherein the setting mechanism is configured to set the pressure of the brush on the floor.

19. The assembly according to claim 1, wherein the brush is fastened to a holder and is fastened thereby to the frame, wherein the holder is fastened to the frame at the location of an adjustable connection which forms part of the setting mechanism.

20. The assembly according to claim 19, wherein the adjustable connection forms a pivot point with a substantially horizontal rotational centre line and is adjustable in horizontal direction for setting the distance between the brush and the pivot point.

21. The assembly according claim 1, wherein the brush is arranged behind the slide when viewed in the direction of travel.

22. The assembly according to claim 19, wherein the slide is fastened to the holder at a location at the side of the adjustable connection which faces away from the brush.

23. The assembly according to claim 1, wherein the slide is concave in top view, with the hollow side oriented forwardly.

24. The assembly according to claim 1, wherein the self-propelled device is self-steering.

25. An unmanned self-propelled device for displacing material present on a floor, comprising a frame with a slide, wherein the frame is provided with at least one rotatable brush, wherein the frame is further provided with a drive mechanism for driving the rotatable brush, wherein the brush is mounted on the frame in such that the operating pressure of the brush is settable by controlling the number of revolutions thereof.

26. An unmanned self-propelled device for displacing material present on a floor, comprising a frame with a slide, wherein the frame is provided with at least one brush, wherein the device is provided a pressure setting mechanism of the brush on the floor.

27. The device according to claim 26, wherein the brush is fastened to a holder and is fastened thereby to the frame, wherein the holder is fastened to the frame at the location of an adjustable connection.

28. The device according to claim 27, wherein the adjustable connection forms a pivot point with a substantially horizontal rotational centre line and is adjustable in horizontal direction for setting the distance between the brush and the pivot point.

29. The device according to claim 26, wherein the device is self-steering.

30. An unmanned self-propelled device for displacing material present on a floor, comprising a frame with a slide, wherein the frame is provided with at least one rotatable brush that is arranged behind the slide, wherein the frame further comprises a drive mechanism for driving the rotatable brush, wherein the device has a longitudinal direction, to which the direction of travel of the device is parallel during operation, wherein the brush is drivable about a horizontal centre line which is transverse to the longitudinal direction.

31. A method of removing material from a stable floor surface with the aid of a slide provided on a mobile device and at least one brush provided on said device, wherein the intensity of the contact of the brush is controlled automatically in dependence on one or more condition parameters.

32. The method according to claim 31, wherein the condition parameter comprises at least one of: the condition of the floor, the surroundings, speed of the device, direction of the device.

33. The method according to claim 31, wherein said intensity is controlled by setting the height of the brush with respect to the floor.

34. The method according to claim 31, wherein said intensity is controlled by setting the part of the weight of the device which is supported on the floor via the brush.

35. The method according to claim 31, wherein the brush is a rotatingly driven brush, wherein said intensity is controlled by setting at least one of: the direction of rotation and the rotational speed of the brush.

36. The method according to claim 35, wherein the device travels over the floor at a speed and the brush is driven in rotation at least partially in dependence on the speed of travel.

37. The method according to claim 36, wherein the brush is driven in rotation at a circumferential speed that is greater than the speed of travel, wherein the direction of rotation of the brush at the location of the contact of the brush with the floor is opposite to the direction of travel.

38. The method according to claim 31, wherein the brush is driven in rotation at a circumferential speed which is equal to the speed of travel, wherein the direction of rotation of the brush at the location of the contact of the brush with the floor is opposite to the direction of travel.

39. The method according to claim 31, wherein the device travels over the floor at a speed, in a selected one of two opposite directions of travel, and the brush is driven in rotation in a direction in dependence on the selected direction of travel.

40. A method of removing material from a stable floor surface with the aid of a slide which is provided on a mobile device and a brush provided on said device, wherein the operating pressure of the brush on the floor is set in dependence on at least one of: the condition of the floor and the surroundings.

41. The method according to claim 40, wherein the pressure of the slide on the floor and the pressure of the brush on the floor is set in mutual dependency.

42. The method according to claim 41, wherein the mutual dependency is according to inverse proportion.

43. The method according to claim 41, wherein there is made use of a brush that is rotatable about a substantially horizontal rotational centre line.

44. The method according to claim 43, wherein the brush is rotatable about a rotational centre line transverse to the direction of travel.

45. The method according to claim 40, wherein the brush is a motor-driven brush.

46. The method according to claim 40, wherein the device is unmanned self-propelled and self-steering.
